(19) United States
(12) Patent Application Publication
(10) Pub. No.: US 2007/0187048 A1
(43) Pub. Date: Aug. 16, 2007

(54) Venetian window with movable elevating blinds

(76) Inventor: Jin-Tang Hung, Taipei (TW)

Correspondence Address: BIRCH STEWART KOLASCH & BIRCH, PO BOX 747, FALLS CHURCH, VA, 22040-0747, US

(21) Appl. No.: 11/352,992

(22) Filed: Feb. 14, 2006

(51) Int. Cl. E06B 9/30

(52) U.S. Cl. 160/168.1 R

(57) ABSTRACT

A Venetian window with movable elevating blinds includes a window frame, a vertical pivotal plate separately installed on internal left and right sides of the window frame, a vertical groove disposed at the pivotal plate for engaging a pivotal portion of a plurality of blinds and moving the blinds vertically up and down, a pivotal hole separately disposed at the top of two side frames and pivotally coupled to the pivotal portion on both sides of the blinds, two surrounding strips for fixing and maintaining each blind in a balanced position and driving each blind to rotate synchronously, a cap disposed at an end of the two pulling strings for passing each blind and fixing it at the bottom of the blind, and a handling knob disposed at another end of a control wheel module, such that the pulling string can be operated to pull the blinds up or down.

### FIELD OF THE INVENTION

The present invention relates to a Venetian window, and more particularly to a movable blinds structure having blinds that can be pulled upward and fixed at the top of a frame of the Venetian window.

### BACKGROUND OF THE INVENTION

Referring to FIG. 1, a traditional Venetian window is generally installed at a position of a window of a construction for providing lights as well as ventilations, and thus traditional windows includes a plurality of transversally arranged oblique blinds and an interval is maintained between two adjacent blinds for allowing outdoor lights to be projected inside a room while allowing fresh air to enter into a room. To achieve the effects of good lighting and ventilation, a Venetian window is usually installed in an original glass window, but the blinds of a traditional Venetian window are fixed and cannot be pulled upward or downward. Further, the blinds cannot be adjusted with different angles or fully shut since the blinds are limited by the vertical path of a light adjusting rod 1. Thus, such Venetian window cannot be used extensively for the household purpose, but the present invention focuses on the design of adjusting the lights in a room and sheltering the direct sunlight to overcome the shortcomings of the prior art Venetian windows that cannot be used according to user requirements and obtain a larger area of ambient lighting as well as improving the visual obstacles of the fixed blinds. In other words, it no longer meets the present requirements if the blinds of the Venetian window cannot be pulled upward and can only be rotated for the light adjusting function.

In view of the shortcomings of the prior art, the inventor of the present invention based on years of experience in the related industry to conduct extensive researches and experiments, and finally invented a Venetian window with movable elevating blinds to overcome the foregoing shortcomings of the prior art Venetian window.

### SUMMARY OF THE INVENTION

The primary objective of the present invention is to provide a Venetian window with movable elevating blinds that comprises a rectangular window frame, an opening separately disposed on an internal side of two side frames which are disposed on both left and right sides of the window frame respectively for receiving a pivotal plate, a vertical groove disposed longitudinally on the pivotal plate for engaging a plurality of vertically arranged blinds with a pivotal portion at an external side for the up and down movements, and both left and right sides of the pivotal portion of the uppermost blind are pivotally coupled to and movably rotated at a pivotal hole disposed above the two side frames, and a ladder-shaped surrounding strip fixes each blind into its position and drives each blind to rotate synchronously, and an end of the two pulling strings is fixed to the left and right caps at the lowest blind and passed through two fixed pulleys for changing directions, and the two pulling strings are pulled to a control wheel module, such that the two pulling strings are fixed to a handling knob. By pulling the pulling strings, each blind is ascended or descended to a predetermined position, and the movable gear can be engaged and fixed with the wheel by pulling the pulling string to a side, or the movable gear can be released by pulling the two pulling strings to the opposite direction in order to pull the blinds up or down.

### BRIEF DESCRIPTION OF THE DRAWINGS

FIG. 1 is a perspective view of a prior art Venetian window;

FIG. 2 is an exploded view of a preferred embodiment of the present invention;

FIG. 3A is a perspective view of a preferred embodiment of the present invention;

FIG. 3B is an enlarged view of a portion of a preferred embodiment of the present invention;

FIG. 3C is another enlarged view of a portion of a preferred embodiment of the present invention;

FIG. 4 is a schematic view of a control wheel module according to a preferred embodiment of the present invention; and

FIG. 5 is a schematic view of pulling up the blinds according to a preferred embodiment of the present invention.

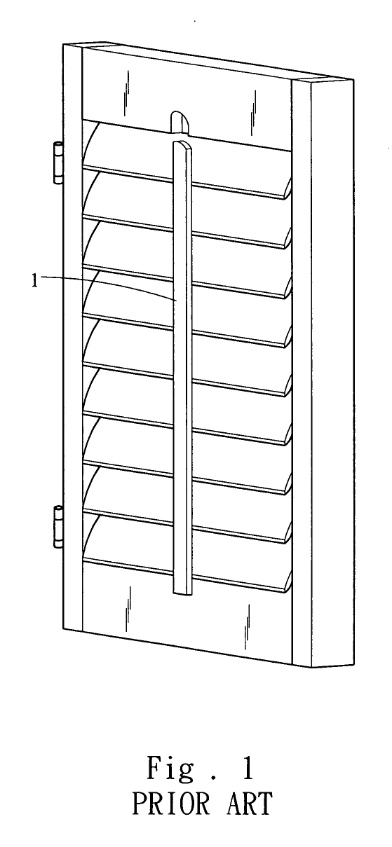

### DETAILED DESCRIPTION OF THE PREFERRED EMBODIMENTS

The present invention will now be described in more detail hereinafter with reference to the accompanying drawings as follows:

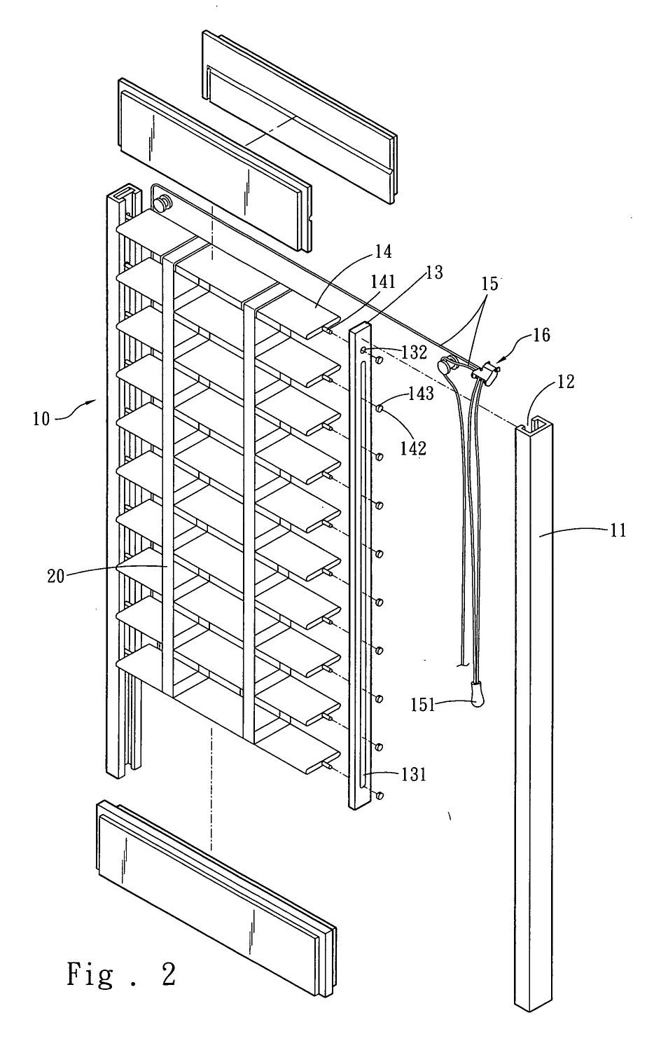

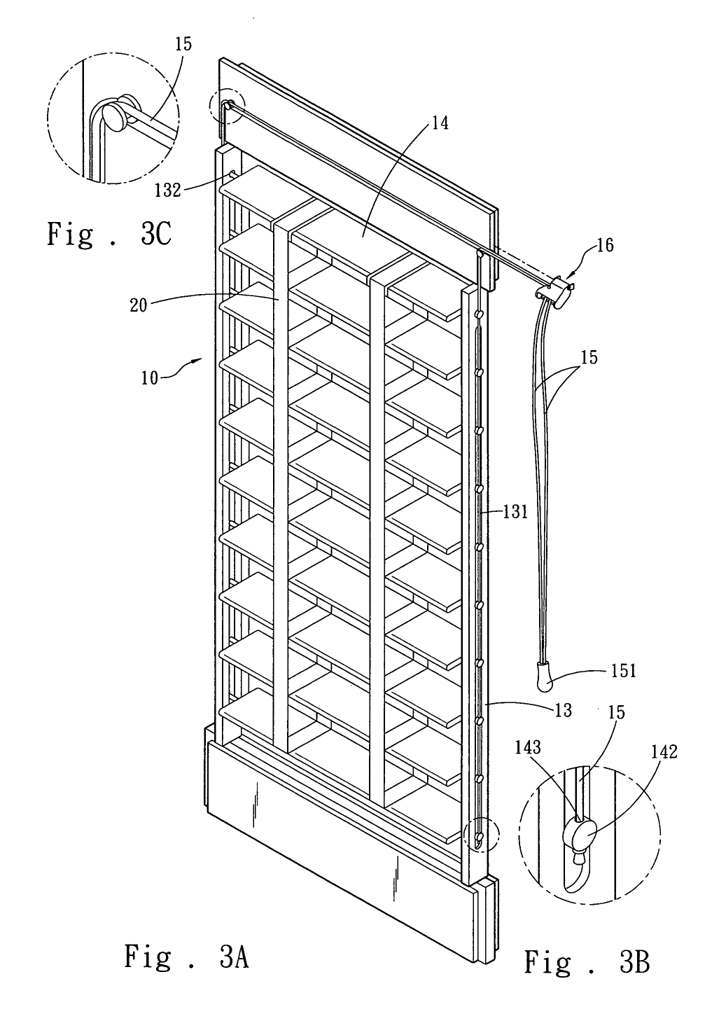

Referring to FIGS. 2 and 3A, a Venetian window with movable elevating blinds of the invention comprises: a rectangular window frame 10; a pair of side frames 11 disposed on both left and right sides of the window frame 10 respectively, and the cross-section of the side frame 11 being U-shaped; an opening 12 formed at an internal side of the side frame 11 for plugging a vertical rectangular pivotal plate 13 precisely therein; a vertical groove 131 disposed vertically on the pivotal plate 13 and penetrating both sides and having a pivotal hole 132 disposed at the top of the vertical groove 131; a plurality of blinds 14 vertically arranged and disposed between the side frames 11, and both external left and right sides of each blind 14 having a protruded pivotal portion 141 passing through the vertical groove 131 of the pivotal plate 13 and being engaged with a cap 142 from an external side of the pivotal plate 13, so that each blind 14 can be ascended or descended along the vertical groove 131, and the pivotal portion 141 at both ends of the highest blind 14 is passed through the pivotal hole 132 at the top of the two pivotal plates 13, such that the highest blind 14 can be rotated only, but cannot be moved up and down.

The end of one of the two pulling strings 15 is passed through a string hole 143 of the cap 142 at a side of each blind 14 and fixed at the bottom of the string hole 143 of the cap 142 of the lowest blind 14 as shown in FIG. 3B, and the other end is wound around a fixed pulley for changing a direction and passed through a control wheel module 16, and another end of the pulling string 15 is fixed to a handling knob 151 to provide a handle for users to pull.

An end of another pulling string 15 is passed through a string hole 143 of a cap 142 on another side of each blind 14 and fixed at the bottom of a string hole 143 of a cap 142 on another side of the lowest blind 14, and the top of another pulling string 15 is wound around another fixed pulley at the top of the side frame 11 for changing a direction as shown in FIG. 3C, and pulled transversally to the control wheel module 16 on the corresponding side and extended downward to connect the handling knob 151.

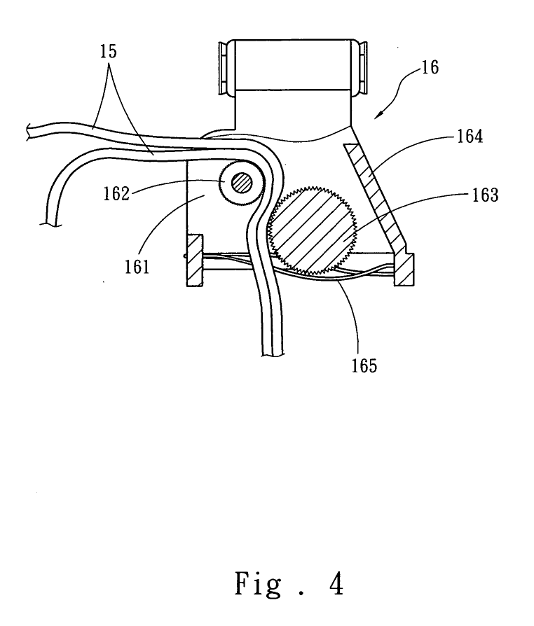

In FIG. 4, the control wheel module 16 includes a hollow box body 161, a wheel 162 pivotally coupled into the box body 161, a movable gear 163 disposed at a lateral side of the wheel 162, a curved line 165 disposed at the bottom of the movable gear 163 for supporting the movable gear 163, and the external side is pressed by a pressing surface 164 disposed on an aslant side of the box body 161, such that the movable gear 163 constantly falls into a recessed position of the curved line 165, and the two pulling strings 15 are wound around a gap between the wheel 162 and the movable gear 163, and the movable gear 163 constantly leans against the wheel 162 due to the gravitation and the limitation of the curved line 165 at the bottom, so as to tightly clamp the two pulling strings 15, and each blind 14 can be pulled up and fixed to the highest position, or fixed at a predetermined height. Users just need to pull both pulling strings 15 simultaneously and tug outside to release the movable gear 163, and thus the two pulling strings 15 can be released to pull the blinds 14 up or down.

Two soft surrounding strips 20 surround all blinds 14, and the front and rear parts of each blind 14 are fixed to the surrounding strips 20, so that any blind 14 can be rotated to drive all other blinds 14 to rotate by the two surrounding strips 20.

In the foregoing structure, if each blind 14 is pulled down, any one of the blinds 14 can be turned to drive the two soft surrounding strips 20 on the left and right sides, so as to drive all blinds 14 to tilt slantingly downward to achieve the effect of sheltering lights. Since the surrounding strips 20 can be folded flexibly, two adjacent blinds 14 can be attached with each other slantingly without being limited by angles, and thus such arrangement can achieve the effect of fully shutting the window for controlling the quantity of wind and light.

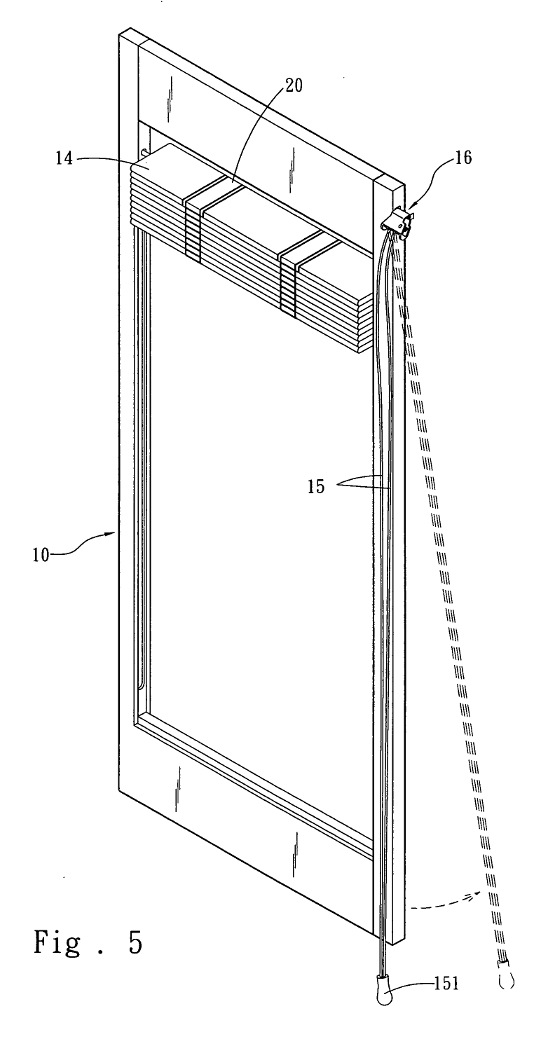

It is worth to point out that users just need to pull the handling knob 151, so that the two pulling strings 15 connected to the caps 142 disposed at both ends of the lowest blind 14 can be lifted to drive the lowest blind 14 to move upward along the vertical groove 131 of the pivotal plate 13 and fixed by the wheel 162 in the control wheel module 16 and clamped by the movable gear 163. Users can pull a certain number of blinds 14 up to the top of the window frame 10 as shown in FIG. 5 or to a predetermined height, and then fix and clamp the blinds 14 into their positions by the control wheel module 16.

In summation of the above description, the present invention herein enhances the performance than the prior art Venetian window and further complies with the patent application requirements and is submitted to the Patent and Trademark Office for review and granting of the commensurate patent rights.

While the invention has been described by means of specific embodiments, numerous modifications and variations could be made thereto by those skilled in the art without departing from the scope and spirit of the invention set forth in the claims.

What is claimed is:

1. A Venetian window with movable elevating blinds, comprising a window frame, an opening separately disposed at an internal side of two side frames on both left and right sides of said window frame for receiving a pivotal plate, a vertical groove disposed longitudinally on said pivotal plate for engaging a pivotal portion protruded from an external side of a plurality of blinds, a cap coupled with said pivotal portion of said blinds from an external side of said pivotal plate, a pivotal hole separately disposed on said two side frames and coupled to said pivotal portion on both left and right sides of the top of said blinds, at least one surrounding strip for surrounding said each blind, two pulling strings, each end of said pulling string passing through said cap on both left and right sides of said each blind and being fixed to the bottom of said cap on both left and right sides of the bottom of said lowest blind, and the top being turned by a positioning wheel and passed through a control wheel module and fixed onto a handling knob.

2. The Venetian window with movable elevating blinds of claim 1, wherein said surrounding strip is a soft strip.

3. The Venetian window with movable elevating blinds of claim 1, wherein said control wheel module comprises a hollow box body having a wheel pivotally coupled to said box body which is pivotally coupled to a wheel, a movable gear disposed on a lateral side of said wheel, and the bottom of said movable gear is supported by a curved line and an external side of said movable gear is pushed by a pressing surface disposed slantingly on a side of said box body, such that said movable gear constantly falls into a recessed position of said curved line, and said pulling string is passed between said wheel and said movable gear.
